(19) United States
(12) Patent Application Publication
(10) Pub. No.: US 2026/0091779 A1
(43) Pub. Date: Apr. 2, 2026

(54) AUTONOMOUS MOBILE VEHICLE CONTROL SYSTEM AND SAFETY TRAJECTORY CONTROL METHOD FOR AUTONOMOUS MOBILE VEHICLE

(71) Applicant: DELTA ELECTRONICS INT'L (SINGAPORE) PTE LTD., Singapore (SG)

(72) Inventors: Muqing CAO, Singapore (SG); Lihua XIE, Singapore (SG); Tzu-Yi HUNG, Singapore (SG)

(21) Appl. No.: 19/325,441

(22) Filed: Sep. 10, 2025

Related U.S. Application Data
(60) Provisional application No. 63/700,134, filed on Sep. 27, 2024.

(30) Foreign Application Priority Data
Aug. 18, 2025 (SG) 10202502315S

(51) Int. Cl. B60W 30/09; B60W 30/095; B60W 30/14; B60W 50/00; B60W 60/00; G06V 20/58

(52) U.S. Cl. CPC B60W 30/09; B60W 30/0956; B60W 30/143; B60W 50/0097; B60W 60/0015; B60W 60/00274; G06V 20/58; B60W 2420/403; B60W 2520/105; B60W 2554/20; B60W 2554/4044; B60W 2554/4045; B60W 2554/80

(57) ABSTRACT

An autonomous mobile vehicle control system performs operations of: projecting a three-dimensional point cloud data to obtain a two-dimensional point cloud data; analyzing a projection distribution of the two-dimensional point cloud data to locate at least one static background object and at least one dynamic moving object in the field; predicting a static safety trajectory of the autonomous mobile vehicle moving in the field and avoiding collision between the autonomous mobile vehicle and the static background object according to a position coordinate of the least one static background object; tracking the movement of the dynamic moving object in the field in real time, and adjusting the static safety trajectory in real time with reference to the movement of the dynamic moving object to obtain a dynamic safety trajectory for controlling the movement of the autonomous mobile vehicle in the field.

### CROSS-REFERENCE TO RELATED APPLICATION

This patent application claims the benefit of U.S. Provisional Patent Application No. 63/700,134, filed Sep. 27, 2024, which is incorporated by reference herein.

### BACKGROUND

### Technical Field

The present disclosure relates to a control system and a control method, and more particularly to an autonomous mobile vehicle control system and a safety trajectory control method for the autonomous mobile vehicle.

### Description of Related Art

The statements in this section merely provide background information related to the present disclosure and do not necessarily constitute prior art.

In recent years, autonomous mobile vehicles (such as self-moving vehicles) have been widely used in human living environments, such as automatic food delivery vehicles in restaurants, automatic transportation vehicles indoors, or autonomous monitoring vehicles that shuttle through crowds. The camera of the autonomous mobile vehicle serves as a sensing device of the autonomous mobile vehicle to detect the conditions around the autonomous mobile vehicle. For example, when an autonomous mobile vehicle moves in an unmanned factory, it only needs to perform image processing to detect the boundaries of the operational field and static objects within the boundaries, and can move freely without colliding with walls or other objects.

However, when an autonomous mobile vehicle moves in a crowded workplace (such as a department store or an outdoor restaurant), the overlap between the crowds and the environment will affect the detection in the workplace. Depending on factors such as crowd density, movement direction and speed, the detection of all objects and boundaries within the workplace will also be affected.

In addition, humans, animals or any objects that can be manipulated or move freely are high uncertainties for autonomous mobile vehicles due to their autonomous mobility, and such high uncertainty can affect the autonomous navigation of autonomous mobile vehicles. The accuracy of image analysis will be affected by factors such as crowd density or movement direction and speed, for example, the accuracy of object detection will be decreased. Moreover, the uncertainty of dynamic behavior will also affect the safety of autonomous navigation of autonomous mobile vehicles. For example, an autonomous mobile vehicle may detect objects directly in front of it. When the autonomous mobile vehicle detects the position of the object, it will bypass the object to avoid collision during its own movement. However, when the autonomous mobile vehicle actually turns to the left and moves forward, still it may collide with the object if the object is also moving to the left at the same time.

Therefore, it has become a critical topic in this field regarding how to overcome the problem of collision caused by misjudgment or calculation delay of autonomous mobile vehicles and improve the navigation planning of autonomous mobile vehicles to maintain safety.

### SUMMARY

In order to overcome the safety problem caused by misjudgment of object or time delay in trajectory planning for autonomous mobile vehicles, the present disclosure proposes an autonomous mobile vehicle control system and a safety trajectory control method applied to the autonomous mobile vehicle to solve the above-mentioned problems.

In an embodiment of the disclosure, an autonomous mobile vehicle control system is provided to control the movement of an autonomous mobile vehicle in a field. The autonomous mobile vehicle control system includes a sensor module and a processing module. The sensor module senses the environment to obtain three-dimensional point cloud data. The processing module is connected to the sensor module and performs the following operations: projecting the three-dimensional point cloud data to a horizontal plane to obtain a two-dimensional point cloud data; analyzing a projection distribution of the two-dimensional point cloud data on the horizontal plane to locate at least one static background object and/or at least one dynamic moving object in the field; predicting a static safety trajectory for the autonomous mobile vehicle to move in the field and avoid a collision with the static background object according to a position coordinate of the least one static background object; tracking a movement of the dynamic moving object in the field in real time during movement of the autonomous mobile vehicle, and adjusting the static safety trajectory in real time with reference to the movement of the dynamic moving object to obtain a dynamic safety trajectory for controlling the movement of the autonomous mobile vehicle in the field so that the autonomous mobile vehicle and the dynamic moving object are maintained away from each other for at least a safety distance.

In another embodiment of the disclosure, a safety trajectory control method for an autonomous mobile vehicle is provided. The safety trajectory control method is performed by an autonomous mobile vehicle control system. The autonomous mobile vehicle control system includes a sensor module, a processing module connected to the sensor module, and an autonomous mobile vehicle. The safety trajectory control method includes steps of: sensing, by the sensor module, in a field to obtain a three-dimensional point cloud data; projecting, by the processing module, the three-dimensional point cloud data to a horizontal plane to obtain a two-dimensional point cloud data; analyzing, by the processing module, a projection distribution of the two-dimensional point cloud data on the horizontal plane to locate at least one static background object and at least one dynamic moving object in the field; predicting, by the processing module, a static safety trajectory of the autonomous mobile vehicle for moving in the field and avoiding collision between the autonomous mobile vehicle and the static background object according to a position coordinate of the least one static background object; tracking, by the processing module, the movement of the dynamic moving object in the field in real time while the autonomous mobile vehicle moves in the field, and adjusting the static safety trajectory in real time with reference to the movement of the dynamic moving object to obtain a dynamic safety trajectory for controlling the movement of the autonomous mobile vehicle in the field so that the autonomous mobile vehicle and the dynamic moving object are maintained away from each other for at least a safety distance.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The present disclosure can be more fully understood by reading the following detailed description of the embodiment, with reference made to the accompanying drawing as follows:

FIG. 1 is a block diagram of an autonomous mobile vehicle control system according to an embodiment of the present disclosure.

FIG. 2 a schematic diagram of an original trajectory and a state-space equation of the vehicle according to an embodiment of the present disclosure.

FIG. 3 is a flowchart of information processing and trajectory calculation of vehicle control operations according to an embodiment of the present disclosure.

FIG. 4 is a block diagram of an autonomous mobile vehicle control system according to another embodiment of the present disclosure.

FIG. 5 is a block diagram of an autonomous mobile vehicle control system according to further another embodiment of the present disclosure.

FIG. 6 is a flowchart of a safety trajectory control method for an autonomous mobile vehicle according to an embodiment of the present disclosure.

### DETAILED DESCRIPTION

Reference will now be made to the drawing figures to describe the present disclosure in detail. It will be understood that the drawing figures and exemplified embodiments of present disclosure are not limited to the details thereof.

An autonomous mobile vehicle is a vehicle system that autonomously plans its own trajectory and completes driving in a dynamic working environment through perception, navigation, localization, planning, and movement control. For example, the autonomous mobile vehicle may be an autonomous vehicle (AV), an autonomous mobile robot (AMR), an autonomous logistics vehicle, an automated machine used in industrial applications (such as an unmanned tractor used in agriculture), an autonomous cleaning vehicle, or an autonomous security patrol vehicle.

In particular, the autonomous mobile vehicle of the present disclosure refers to a robot or vehicle that moves only within a specified field, building, or area, and detects specific objects in the specified field, building, or area through its own system to avoid collision with these objects during movement. The autonomous mobile vehicle of the present disclosure is different from an autonomous driving vehicle that is used on public roads and navigates and moves autonomously to the destination based on traffic safety rules and traffic signs, and avoids traffic accidents with unspecified road users and other vehicles during the process. More specifically, the autonomous mobile vehicle of the present disclosure is used to provide services in a specified field, building, or area, such as delivering meals, delivering goods, cleaning, or guiding, etc., and is different from the autonomous driving vehicle that allows users to ride and transport users to their destination via public roads.

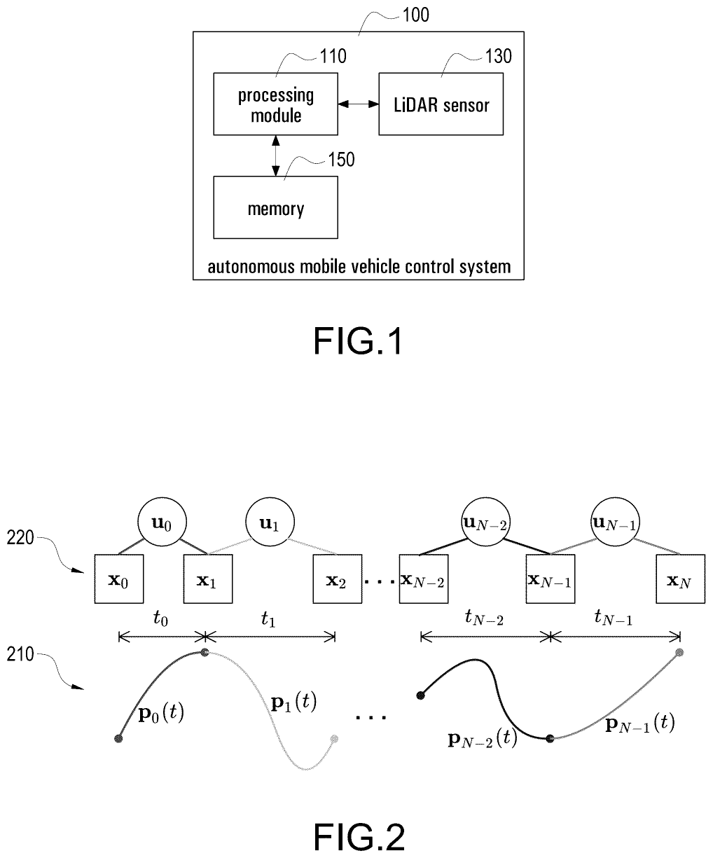

FIG. 1 is a block diagram of an autonomous mobile vehicle control system according to an embodiment of the present disclosure.

In one embodiment, the autonomous mobile vehicle control system 100 is used to control the movement of a vehicle body (not shown) of an autonomous mobile vehicle in an environment. There exist correlations between the autonomous mobile vehicle control system 100 and the vehicle body in terms of structural hardware integration and functional control feedback. For the sake of brevity, the present disclosure does not limit the structural and functional design of the vehicle.

The autonomous mobile vehicle control system 100 includes, at least but not limited to, a processing module 110, a LiDAR (Light Detection and Ranging) sensor 130, and a memory 150. The processing module 110 is connected to the LiDAR sensor 130 and the memory 150. When the vehicle body of the autonomous mobile vehicle moves in the field, the autonomous mobile vehicle control system 100 obtains sensed data, plans trajectories, and updates the movement control of the vehicle.

The autonomous mobile vehicle control system 100 detects static background objects in the field (including the boundaries of the field and movable objects, such as walls, cabinets, goods, etc.), and considers the movement of dynamic moving objects (including all living or non-living things that can move autonomously) in the field. The autonomous mobile vehicle control system 100 avoids the vehicle body from colliding with any object during movement by simultaneously referring to the positions of static background objects and predicting the movements of dynamic moving objects.

In some embodiments, the field may be a field or building with a specific range, such as restaurant, factory, office building, hospital, hotel, amusement park, or airport. More specifically, these fields have known ranges and sizes, and the autonomous mobile vehicle of the present disclosure will only move and provide services within the known range of this field or building, and will not exit this range, nor provide services beyond preset content.

Static background objects may be facilities, equipment, decorations, furniture, or movable objects temporarily stored in these places or buildings in still state, and dynamic moving objects are people or objects that move within the known range of these places or buildings. Taking restaurant as an example, static background objects may be counters, kitchen utensils, tables, chairs, and decorations, etc., and dynamic moving objects may be waiters/waitresses, customers, and food delivery carts moving around in the restaurant. For another example, static background objects in a factory may be machines, conveyor belts, containers, pallets, temporarily stacked goods, and temporarily parked vehicles, and dynamic moving objects may be production line personnel, carts, cranes, trucks, or other autonomous mobile vehicles moving in the factory.

The LiDAR sensor 130 is disposed on the vehicle body and moves along with the vehicle body, and simultaneously senses the environment during movement of the vehicle body to obtain three-dimensional point cloud data. The three-dimensional point cloud data is a dense data set generated by the LiDAR sensor 130 and includes spatial position information (e.g., three-dimensional coordinates (x, y, z)), sensed data, and timestamps.

The memory 150 stores a plurality of program codes, and when the program codes are loaded into the processing module 110, the processing module 110 executes safety trajectory control operations applied to an autonomous mobile vehicle (e.g., a self-moving vehicle), such as generating trajectory planning instructions for manipulating the vehicle body to ensure that the autonomous mobile vehicle maintains a safety distance away from all objects.

The processing module 110 receives the three-dimensional point cloud data and calculates safety trajectory control operations that can be used to control the vehicle in real time. In one embodiment, in order to simplify processing complexity and increase efficiency, the processing module 110 projects the three-dimensional point cloud data to a horizontal plane to obtain a two-dimensional point cloud data, and analyzes a projection distribution of the two-dimensional point cloud data on the horizontal plane to locate static background objects and dynamic moving objects in the environment. Subsequently, the processing module 110 predicts a static safety trajectory that allows the vehicle body to move in the field and avoids collision between the vehicle body and the static background objects according to position coordinates of the static background objects. Furthermore, the processing module 110 tracks the movement of dynamic moving objects in the field in real time when the vehicle moves in the field, and adjusts the static safety trajectory in real time with reference to the movement of the dynamic moving objects to obtain a dynamic safety trajectory for controlling the movement of the vehicle body in the field so that the moving vehicle body and the dynamic moving objects are maintained away from each other with at least a safety distance.

As mentioned above, the autonomous mobile vehicle and the dynamic mobile object move within a field or building with a known specific range, and the autonomous mobile vehicle and the dynamic mobile object share the same aisles and regions within the specific range. That is, the moving trajectories of the autonomous mobile vehicles and the dynamic moving objects may be the same and overlap to some extent. In contrast, on public roads, autonomous driving vehicles travel on lanes, while pedestrians walk on sidewalks or zebra crossings, and their usage scenarios are different from the present disclosure. Therefore, in the present disclosure, the LiDAR sensor 130 measures surroundings of the vehicle body of the autonomous mobile vehicle to obtain the three-dimensional point cloud data, and the processing module 110 tracks the movement of dynamic moving objects nearby the vehicle body according to the processed two-dimensional point cloud data. Furthermore, since the autonomous mobile vehicle can move up to 360 degrees within a specific range, it is different from the situation where an autonomous driving vehicle on a public road should only move straight along the road direction (a single direction). Therefore, when the processing module 110 adjusts the static safety trajectory according to the above-mentioned data to obtain a dynamic safety trajectory for controlling the movement of the vehicle, it mainly generates a moving trajectory that causes the vehicle to rotate or move up to 360 degrees on the horizontal plane formed by the x-axis and the y-axis so that the moving vehicle can maintain at least a safety distance away from multiple dynamic moving objects in all directions.

The three-dimensional point cloud data is a dense data set that includes spatial position information (e.g., three-dimensional coordinates (x, y, z)), sensed data, and timestamps. In one embodiment, the processing module 110 projects the three-dimensional coordinates into two-dimensional coordinates on a horizontal plane. For example, the Z axis is used as the vertical axis (height), and the horizontal plane is the XY plane formed by the X axis and the Y axis. The two-dimensional point cloud data projected to the horizontal plane is a dense data set including horizontal position information (e.g., two-dimensional coordinates (x, y)), sensed data, and timestamps.

Since one of the considerations of the autonomous mobile vehicle control system 100 is how to plan a safety trajectory, the two-dimensional point cloud data without (excluding) the height information (z coordinate) can reduce the amount of calculation of the processing module 110.

In one embodiment, the processing module 110 analyzes the projection distribution of the two-dimensional point cloud data on the horizontal plane to locate the positions (including coordinate information and object outlines) of static background objects and dynamic moving objects in the field. For example, the processing module 110 obtains the position information of the object on the horizontal plane at each time point through the coordinate positions and the sensed data to form the projection distribution. In one embodiment, the processing module 110 may determine whether the sensed object corresponding to the projection distribution is a static background object or a dynamic moving object according to the position information over a period of time. For example, if the position information within a period of time is substantially the same, the processing module 110 determines that the sensed object corresponding to the projection distribution belongs to a static background object. If the distribution of multiple coordinate points within a period of time is in an adjacent relationship and presents a trajectory, the processing module 110 determines that the sensed object corresponding to the projection distribution is a dynamic moving object.

The processing module 110 predicts a static safety trajectory for controlling the movement of the vehicle body according to the position coordinates of the static background objects to avoid collision with the static background objects. In one embodiment, the processing module 110 calculates a static safety trajectory according to the position distribution of static background objects and with reference to factors such as the maximum speed or curvature limit of the autonomous mobile vehicle. For example, the processing module 110 uses a spatial constraint function (formula (1)) to control the distance between the vehicle body and the boundaries of the static background objects.

$${G}_{ζ} ( p , \dot{p} ) = {A}^{T} ( p + {Rl}_{e} ) - b \leq 0 \qquad formula ( 1 )$$

where p is the current position of the autonomous mobile vehicle, lₑ is the geometric vertex of the shape of the autonomous mobile vehicle, and A and b are the hyperplane parameters that describe the static background objects.

The spatial constraint function is used to constrain the trajectory of the vehicle body in the state space domain so that the generated static safety trajectory can ensure that the vehicle body will not collide with other objects in the field.

In one embodiment, as the vehicle body moves in the field, the processing module 110 tracks the movements of all dynamic moving objects in real time. For example, upon determining a dynamic moving object through projection distribution within a period of time, the processing module 110 marks an identifier to the sensed object corresponding to the projection distribution, i.e., the dynamic moving object, according to the features of the projection distribution. Accordingly, in response to the processing module 110 locating the dynamic moving objects, different dynamic moving objects are indicated according to the identifiers, and the positions of the dynamic moving objects are continuously tracked with the identifiers.

In one embodiment, the processing module 110 adjusts the static safety trajectory in real time with reference to the movement of the dynamic moving objects to obtain a dynamic safety trajectory, which is used to control the movement of the vehicle body in the field. For example, the processing module 110 uses a dynamic-safety constraint function (formula (2)) to control the safety distance between the vehicle and the dynamic moving object.

$${G}_{Θ} ( p , \dot{p} , t ) = {d}_{m} - U ( E ( p , \dot{p} ) , {O}_{u} ( t ) ) \leq 0 \qquad formula ( 2 )$$

where dₘ is the minimum safety distance, and U is the actual distance between the vehicle and the dynamic moving object.

When the processing module 110 detects a dynamic moving object, a dynamic-safety constraint function is used to impose limits on the movement of the vehicle body so that during movement of the vehicle body, every position point of the vehicle body between the initial position and the positions after a short period of time will continuously maintain at least a safety distance away from the dynamic moving object.

In one embodiment, the processing module 110 uses a state-space equation as the space-time trajectory optimization framework. Specifically, the processing module 110 converts the original trajectory of the vehicle body moving in the field into a state-space equation including the position information, speed, and acceleration of the vehicle body. In particular, the static safety trajectory and the dynamic safety trajectory are trajectories represented by state-space equations, and the original trajectory includes coordinate parameters and time parameters.

How the processing module 110 converts the original trajectory into the state-space equation is described as follows.

First, the original trajectory of the vehicle is expressed as formula (3):

$${p}_{k} ( t ) = {C}_{k}^{T} b ( t ) , t ∈ [ 0 , {t}_{k} ] \qquad formula ( 3 )$$

where pₖ is the position coordinate of the vehicle body in the kth segment (two-dimensional coordinate), Cₖ∈ [symbol] ^{(n+1)×2} is the coefficient matrix, and b(t)=[1, t, t², . . . , tⁿ] T is the n-order monomial basis.

Considering the total time range [0, τ_{N}], the original trajectory of the vehicle is expressed by formula (4):

$$p ( t ) = {p}_{k} ( t - {τ}_{k} ) = {C}_{k}^{T} b ( t - {τ}_{k} ) , t ∈ [ {τ}_{k} , {τ}_{k + 1} ] \qquad formula ( 4 )$$

$$where$$

$${τ}_{0} = 0 and {τ}_{k} = {\sum }_{i = 0}^{k - 1} {t}_{i} .$$

After conversion, the state-space equation of the vehicle can be expressed as formula (5):

$${x}_{k + 1} = A ( {t}_{k} ) {x}_{k} + B ( {t}_{k} ) {v}_{k} := f ( {x}_{k} , {u}_{k} ) \qquad formula ( 5 )$$

where xₖ is the state parameter of the kth segment (e.g., position or speed), vₖ is the speed of the kth segment, and uₖ is the control parameter of the kth segment (e.g., acceleration), where

$${u}_{k} = {[ {v}_{k}^{T} , {t}_{k} ]}^{T} .$$

In particular, the processing module 110 refers to the actual state of the vehicle body and introduces corresponding parameters into the state-space equation to obtain the static safety trajectory and the dynamic safety trajectory corresponding to the actual state of the vehicle body.

In some embodiments, the processing module 110 refers to the type and moving speed of the dynamic moving objects in the field, and correspondingly adjusts the moving speed of the autonomous mobile vehicle indicated by the dynamic safety trajectory. For example, if the dynamic moving object is a living being (such as a person or a group of people), when it is determined that the moving direction of the dynamic moving object is the same as or similar to the moving direction of the autonomous moving vehicle (for example, the angle difference is less than a preset value), the processing module 110 will adjust the moving speed indicated by the dynamic safety trajectory so that the moving speed of the autonomous moving vehicle is not higher than the moving speed of the dynamic moving object. Specifically, the autonomous mobile vehicle of the present disclosure is a supporting tool in a specific field and thus it should move and provide services without affecting people in the field. This is different from the situation where when a moving object (such as a pedestrian or other vehicle) is detected on a public road, the autonomous driving vehicle may be controlled to stop moving or accelerate to overtake the moving object.

On the other hand, when the autonomous mobile vehicle moves according to the dynamic safety trajectory and changes the moving direction, the LiDAR sensor 130 will still continue to detect surroundings and the processing module 110 will continue to analyze sensed data. When the autonomous mobile vehicle changes its moving direction and there is still one or more dynamic moving objects nearby, the processing module 110 will adjust the dynamic safety trajectory to control the speed and/or rotation radius of the autonomous mobile vehicle so that the autonomous mobile vehicle can maintain the safety distance with multiple dynamic moving objects in multiple trajectory directions.

In the case that the processing module 110 determines, after analysis, that there are too many dynamic moving objects around the autonomous mobile vehicle and it is difficult for the autonomous mobile vehicle to maintain safety distances with all dynamic moving objects by adjusting the dynamic safety trajectory, the processing module 110 further searches for a proper stopping point according to the three-dimensional point cloud data/two-dimensional point cloud data so that the autonomous mobile vehicle may move to the stopping point and temporarily stop moving. This is in order to avoid collision of the autonomous mobile vehicle due to failure to maintain safety distances with multiple dynamic moving objects around it. On the other hand, when the autonomous mobile vehicle moves according to a dynamic safety trajectory, and the processing module 110 determines that one or more dynamic moving objects around the autonomous mobile vehicle have caused difficulties of movement, it can also calculate and find an alternative trajectory according to the three-dimensional point cloud data/two-dimensional point cloud data, and then readjust the dynamic safety trajectory so that the autonomous mobile vehicle moves along the alternative trajectory instead.

FIG. 2 is a schematic diagram of an original trajectory and a state-space equation of the vehicle body according to an embodiment of the present disclosure.

The original trajectory 210 of the vehicle body can be expressed by formula (3), which is the position information of the vehicle body at different time points. In one embodiment, the original trajectory 210 of the vehicle body is the center position of the vehicle body or the center position of the rear wheels at each time point t. Through the conversion operation, the original trajectory 210 of the vehicle body is converted into the state-space equation 220 of the vehicle body. The state-space equation of the vehicle body can be expressed by formula (5). In this embodiment, the state-space equation 220 converts the representation of the movement of the vehicle body from an n-th order polynomial (the original trajectory 210) to an equation (the state-space equation 220) whose parameters include the position, speed, and acceleration of the vehicle body. Specifically, the state-space equation 220 is expressions of position, speed, and/or acceleration of the vehicle body.

The above-mentioned conversion operation reduces the number of parameters used for representing the original trajectory 210 of the vehicle body by using a space-time trajectory optimization framework. The number of parameters used by the state-space equation 220 is less than the number of parameters used for the polynomial of the original trajectory 210, and the parameters used in the state-space equation 220 are also relatively simple. The conversion operation is to convert the movement representation of the vehicle body. In addition to simplifying the movement representation of the vehicle body to reduce the complexity of calculation, it can also shorten the time required for trajectory planning and trajectory adjustment in a dynamically changing environment and increase the efficiency of calculation.

When the vehicle body is in an initialization state, the processing module 110 uses the state-space equation 220 to generate an initial static trajectory. The initial static trajectory is the initial trajectory at the beginning, which has not yet been adjusted by considering any object.

Subsequently, after the processing module 110 analyzes the projection distribution of the two-dimensional point cloud data on the horizontal plane and locates the static background object(s), the spatial geometric boundary coordinates of the static background object(s) are used to adjust the initial static trajectory to generate a static safety trajectory that avoids collision of the vehicle body with the static background object(s).

Considering that there is one or more free-moving objects in the environment, if the autonomous mobile vehicle performs movement control only according to the current condition, it may cause a collision with an object in the next moment after moving. Therefore, the autonomous mobile vehicle needs to take these free-moving objects into consideration and control the movement of the vehicle body in a predictive manner to maintain a safety distance.

In one embodiment, the processing module 110 predicts a future moving trajectory of the dynamic moving object in the field. The future moving trajectory may be the moving trajectory of the dynamic moving object in a short period of time. Subsequently, the processing module 110 adjusts the static safety trajectory according to the future m trajectory and the movement of the vehicle body to obtain a dynamic safety trajectory for the actual movement of the vehicle.

The processing module 110 adjusts the target position and target speed of the vehicle body at each position parameter in real time according to at least one of a moving trajectory of the autonomous mobile vehicle, a required time to reach a road segment, and a penalty parameter for not reaching a target road segment so as to control the autonomous mobile vehicle to move smoothly in the field.

In one embodiment, the processing module 110 uses an objective function with reference to the state of the environment (such as walls, furniture, etc.) to optimize the static safety trajectory to obtain the dynamic safety trajectory. The parameters of the objective function include the moving trajectory of the autonomous mobile vehicle, the required time to reach the road segment, and the penalty parameter for not reaching the target road segment.

The objective function can be expressed by formula (6):

$$J ( C , T ) = {\sum }_{k = 0}^{N - 1} ( {‖ {x}_{k} - {x}_{k , g} ‖}_{{Q}_{k}}^{2} + {\int }_{0}^{{t}_{k}} {\sum }_{i = 1}^{m} {η}_{i , k} {‖ {p}_{k}^{( i )} ( t ) ‖}^{2} dt + {w}_{k} {t}_{k}^{2} ) + {‖ {x}_{N} - {x}_{N , g} ‖}_{{Q}_{N}}^{2} \qquad formula ( 6 )$$

where xₖ is the current state, x_{k,g} is the target state, η_{i,k} is the smoothness penalty weighting, and wₖ is the time penalty weighting.

In one embodiment, the processing module 110 dynamically controls the vehicle body to move smoothly in the field and maintain safety distances with the dynamic moving objects by adjusting in real time at least one of a maximum longitudinal speed, a maximum longitudinal acceleration, a maximum lateral acceleration, and a front wheel steering angle limit of the vehicle body.

As the autonomous mobile vehicle continues to move, all states and conditions will change accordingly. Therefore, the processing module 110 needs to monitor each state and condition in real time, and use the objective function to dynamically adjust the static safety trajectory in real time so as to obtain the dynamic safety trajectory that is most suitable for the current state and condition of the vehicle body, and optimize the dynamic safety trajectory.

In particular, in the processing of using the objective function to optimize the dynamic safety trajectory, the smaller the value of the objective function, the closer the trajectory result is to the ideal requirement (for example, maintaining a suitable safety distance away from all objects and moving smoothly). By continuously adjusting parameters (such as the above-mentioned state parameters or control parameters, or weightings, etc.), and adding penalty conditions in some conditions, the result of the objective function is modified to fit with the ideal goal better.

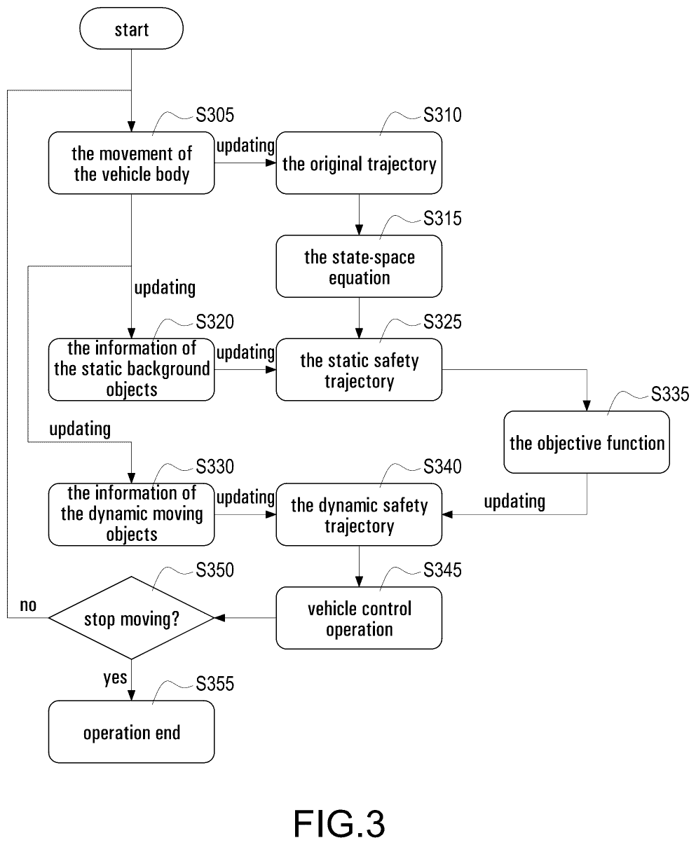

FIG. 3 is a flowchart of information processing and trajectory calculation of vehicle control operations according to an embodiment of the present disclosure.

As shown in FIG. 3, the autonomous mobile vehicle control system 100 controls the movement of the vehicle body (step S305), and continuously updates the original trajectory of the vehicle body moving in the field (step S310). The autonomous mobile vehicle control system 100 converts the original trajectory into the state-space equation (step S315) to simplify the calculation model for processing.

As the vehicle body moves, the surrounding conditions of the environment will also change. The autonomous mobile vehicle control system 100 will update the information of the static background objects in real time (step S320). In order to prevent the vehicle body from colliding with static background objects, the autonomous mobile vehicle control system 100 considers information of static background objects (such as chair positions) and uses state-space equations to update the static safety trajectory (step S325). In the meantime, as the vehicle body moves, the autonomous mobile vehicle control system 100 also needs to update the information of the dynamic moving objects (step S330).

Consequently, the autonomous mobile vehicle control system 100 applies the updated information of the dynamic moving objects to the objective function (step S335) to update the dynamic safety trajectory (step S340) so as to ensure that the vehicle body maintains at least a safety distance away from the dynamic moving objects and the static background objects.

The autonomous mobile vehicle control system 100 uses the dynamic safety trajectory to perform vehicle control operations (step S345), and continues to control the movement of the vehicle and recursively executes the above-mentioned operations (step S350) until the task is completed or any interruption ends the operations (step S355).

In one embodiment, step S310 and step S315 may be initial steps. For example, when the autonomous mobile vehicle control system 100 returns to step S305 from step S350, steps S310 and S315 may be skipped, and step S320 (updating of information of static background objects in real time) can be directly executed to calculate subsequent steps such as static safety trajectory and dynamic safety trajectory.

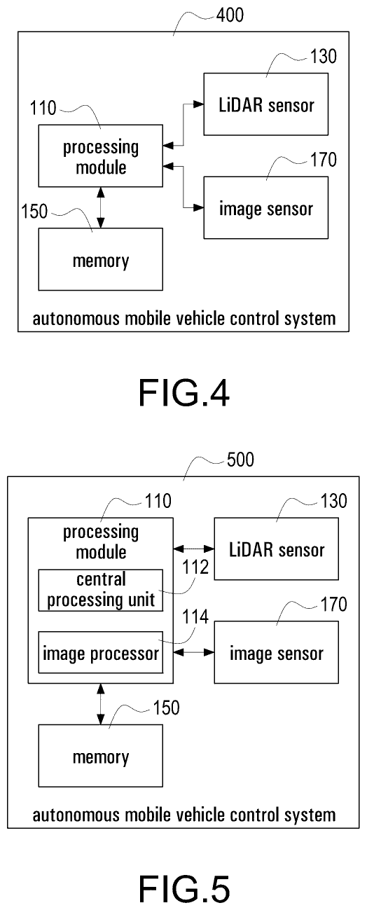

FIG. 4 is a block diagram of an autonomous mobile vehicle control system according to another embodiment of the present disclosure.

Compared with the autonomous mobile vehicle control system 100 of FIG. 1, the autonomous mobile vehicle control system 400 of FIG. 4 is different in that a multimodal sensor module (not shown) is provided. The multimodal sensor module includes a LiDAR sensor 130 and an image sensor 170. In this embodiment, the autonomous mobile vehicle control system 400 includes a processing module 110, a LiDAR sensor 130, an image sensor 170, and a memory 150. The processing module 110 is connected to the LiDAR sensor 130, the image sensor 170, and the memory 150.

The LiDAR sensor 130 is disposed on the vehicle body and moves with the vehicle body, and simultaneously senses the field during the movement of the vehicle body to obtain three-dimensional point cloud data.

On the other hand, the image sensor 170 may also be disposed on the vehicle body and moves with the vehicle body, and simultaneously senses the field during the movement of the vehicle body to obtain image data. The image data may include position information (such as two-dimensional coordinates), pixels, and timestamps.

In one embodiment, the image sensor 170 and the LiDAR sensor 130 are disposed at very close positions (e.g., adjacent positions based on the volume constraints of the components) so that the coordinate points of the objects presented in the image data of the image sensor 170 and the point cloud data of the LiDAR sensor 130 are close to each other. In other words, the object presented in the image data and the object presented in the point cloud data of the LiDAR sensor 130 both represent a certain object in the environment. For example, taking a camera coordinate system of the image sensor 170 as a reference, the first pixel in the upper left corner of the picture is the origin, the X axis is the axis from left to right in the picture, and the Z axis is the axis from top to bottom in the picture. In some conditions, the processing module 110 needs to convert the camera coordinate system into a world coordinate system so that it can be consistent with the coordinate system of the three-dimensional point cloud data of the LiDAR sensor 130. Therefore, when the image sensor 170 and the LiDAR sensor 130 are disposed in very close positions, the sensed data of the two sensors will point to the same coordinate position.

In one embodiment, the processing module 110 projects the three-dimensional point cloud data to a horizontal plane to obtain two-dimensional point cloud data, and uses the two-dimensional point cloud data to detect a first object in the environment. For example, the processing module 110 removes the height information of the three-dimensional point cloud data to obtain the two-dimensional point cloud data, and analyzes the projection distribution of the two-dimensional point cloud data on the horizontal plane. The processing module 110 detects the first object in the environment by projecting the distribution (according to the projection distribution). The first object includes static background objects and dynamic moving objects. This embodiment does not limit the number of first object detected from the projection distribution. For the sake of brevity, the first object represents one or more objects detected through the two-dimensional point cloud data.

In the autonomous mobile vehicle control system 400, the purpose of the LiDAR sensor 130 is to provide environment information in a three-dimensional space and provide sensed information in a large range, but the resolution is low, that is, the sensed data has errors. On the other hand, the characteristic of the image sensor 170 is to provide details of environment information, and the resolution is higher than that of the LiDAR sensor 130. That is, the error of the sensed data is lower, but it is not suitable for detecting a large range of environment structures. Therefore, the autonomous mobile vehicle control system 400 combines the LiDAR sensor 130 and the image sensor 170 to confirm the point cloud data of a specific range by using the image data with lower errors so as to increase the accuracy of object tracking.

In one embodiment, the processing module 110 analyzes features of the image data to detect a second object in the environment. For example, the processing module 110 detects the second object using image-based feature extraction. The second object includes static background objects and dynamic moving objects. This embodiment does not limit the number of second objects detected by the image-based feature extraction. For the sake of brevity, the second object represents one or more objects detected through the image data.

Subsequently, the processing module 110 uses the features of the second object to confirm the first object in the environment to obtain a tracking object in the environment. In particular, the tracking object includes static background object(s) and/or dynamic moving object(s). For example, the features of the second object include position information, pixels, and timestamps. The coordinate range of the first object is corrected by excluding point cloud data that is not within the coordinate range of the second object by using the coordinates of the second object. The region obtained after correcting the coordinate range of the first object is referred to as the tracking object region. In one embodiment, the processing module 110 locates static background objects and dynamic moving objects according to tracking object region.

In this embodiment, after obtaining the three-dimensional point cloud data and before projecting the three-dimensional point cloud data to the two-dimensional point cloud data, the processing module 110 first excludes the point cloud data that is not within the scope of the image data so as to refine the three-dimensional point cloud data. Subsequently, the refined three-dimensional point cloud data is projected to the two-dimensional point cloud data, and the accuracy of the analyzed objects is increased.

In one embodiment, the first object and the second object refer to a circled coordinate region, which may be an outline of an object or a region of interest, but the present disclosure is not limited thereto.

FIG. 5 is a block diagram of an autonomous mobile vehicle control system according to further another embodiment of the present disclosure.

Compared to the autonomous mobile vehicle control system 400 of FIG. 4, the processing module 110 of the autonomous mobile vehicle control system 500 of FIG. 5 further includes a central processing unit 112 and an image processor 114. The central processing unit 112 processes the point cloud data of the LiDAR sensor 130 and the control operation of the autonomous mobile vehicle. The image processor 114 processes image analysis operations of the image sensor 170, such as using image data to detect a second object in the environment.

The central processing unit 112 may be a general-purpose computing core that executes control instructions in higher efficiency. On the other hand, the image processor 114 is dedicated to processing image data, and executes image operation algorithms more efficiently. Therefore, the processing module 110 combines the central processing unit 112 and the image processor 114 to increase the overall computing performance.

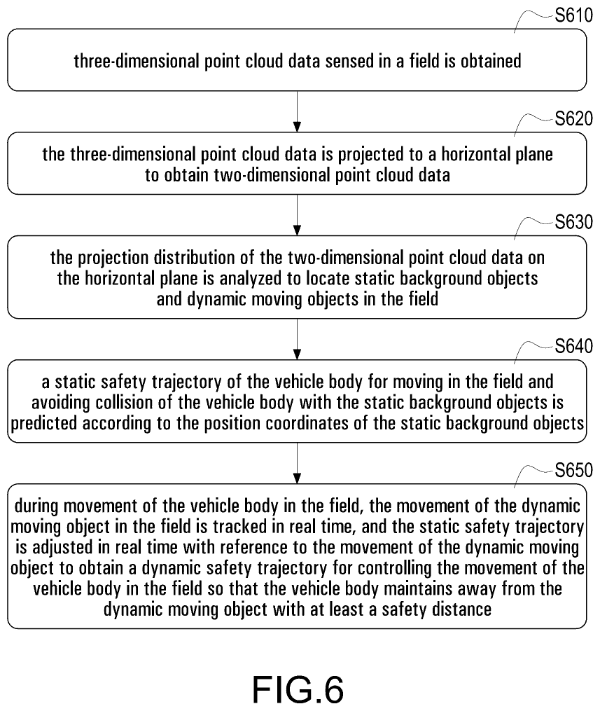

FIG. 6 is a flowchart of a safety trajectory control method for an autonomous mobile vehicle according to an embodiment of the present disclosure. The safety trajectory control method may be executed by the autonomous mobile vehicle control systems 100,400,500 of FIGS. 1,4,5.

In step S610, three-dimensional point cloud data sensed in a field is obtained.

In step S620, the three-dimensional point cloud data is projected to a horizontal plane to obtain two-dimensional point cloud data.

In step S630, the projection distribution of the two-dimensional point cloud data on the horizontal plane is analyzed to locate static background objects and dynamic moving objects in the field.

In step S640, a static safety trajectory of the vehicle body for moving in the field and avoiding collision of the vehicle body with the static background objects is predicted according to the position coordinates of the static background objects.

In step S650, during movement of the vehicle body in the field, the movement of the dynamic moving object in the field is tracked in real time, and the static safety trajectory is adjusted in real time with reference to the movement of the dynamic moving object to obtain a dynamic safety trajectory for controlling the movement of the vehicle body in the field so that the vehicle body could maintain away from the dynamic moving object with at least a safety distance.

In one embodiment, the processing module 110 is, for example but not limited to, a digital signal processor (DSP), an application specific integrated circuit (ASIC), a central processing unit (CPU), a system on chip (SoC), a field programmable gate array (FPGA), a network processor chip, a graphics processing unit (GPU), or a combination of the above components. In one embodiment, the CPU 112 may be replaced by a component among above components other than the CPU.

In one embodiment, the memory 150 is, for example but not limited to, a random-access memory (RAM), a flash memory (Flash memory), a read only memory (ROM), a hard disk drive (HDD), a solid-state drive (SSD), an optical storage device, or a combination of the above elements.

In summary, the present disclosure proposes an autonomous mobile vehicle control system and a safety trajectory control method for autonomous mobile vehicle, which simplifies the complexity of static safety trajectory calculation by converting the original trajectory into a state-space equation. In addition, by finding the static safety trajectory, it is ensured that the movement of the autonomous mobile vehicle (such as a self-moving vehicle) will not collide with static background objects. Subsequently, dynamic safety trajectory is obtained by adjusting the static safety trajectory using the objective function and according to the information of static background objects and dynamic moving objects so as to further ensure that the autonomous mobile vehicle can maintain a safety distance away from all moving objects. In addition, the objective function is optimized according to at least one of below factors: maximum longitudinal speed, maximum longitudinal acceleration, maximum lateral acceleration, and front wheel steering angle limit of the vehicle so as to ensure that the autonomous mobile vehicle can slow down or stop when a dynamic moving object approaches without sudden acceleration or turning. Consequently, the autonomous mobile vehicle can maintain a safety distance with environment objects and meanwhile exhibit stable and smooth control features, which better conforms with human behavior patterns.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An autonomous mobile vehicle control system configured to control movement of an autonomous mobile vehicle in a field, the autonomous mobile vehicle control system comprising:
a sensor module configured to sense the field to obtain a three-dimensional point cloud data, and
a processing module connected to the sensor module and configured to perform the following operations of:
projecting the three-dimensional point cloud data to a horizontal plane to obtain a two-dimensional point cloud data,
analyzing a projection distribution of the two-dimensional point cloud data on the horizontal plane to locate at least one static background object and/or at least one dynamic moving object in the field,
predicting a static safety trajectory for the autonomous mobile vehicle to move in the field and avoid a collision with the static background object according to a position coordinate of the least one static background object, and
tracking a movement of the dynamic moving object in the field in real time during movement of the autonomous mobile vehicle, and adjusting the static safety trajectory in real time with reference to the movement of the dynamic moving object to obtain a dynamic safety trajectory for controlling the movement of the autonomous mobile vehicle in the field so that the autonomous mobile vehicle and the dynamic moving object are maintained away from each other for at least a safety distance.

2. The autonomous mobile vehicle control system as claimed in claim 1, wherein the environment has a known specific range, and the autonomous mobile vehicle and the dynamic moving object share the same aisles and regions within the specific range; and wherein the sensor module is configured to sense surroundings of the autonomous mobile vehicle to obtain the three-dimensional point cloud data; the processing module is configured to track the movement of the dynamic moving object nearby the autonomous mobile vehicle and generate the dynamic safety trajectory that allows the autonomous mobile vehicle to rotate or move up to 360 degrees on a horizontal plane defined by an x-axis and a y-axis such that the autonomous mobile vehicle maintains the safety distance away from a plurality of dynamic moving objects in all directions.

3. The autonomous mobile vehicle control system as claimed in claim 1, wherein the processing module is configured to convert an original trajectory of the autonomous mobile vehicle in the field into a state-space equation comprising a position information, a speed, and an acceleration of the autonomous mobile vehicle; wherein the static safety trajectory and the dynamic safety trajectory are trajectories represented by the state-space equation; wherein the original trajectory comprises a coordinate parameter and a time parameter.

4. The autonomous mobile vehicle control system as claimed in claim 3, wherein the processing module is configured to generate an initial static trajectory by using the state-space equation to, and adjust the initial static trajectory by using a spatial geometric boundary coordinate of the static background object to generate the static safety trajectory that avoids the collision of the autonomous mobile vehicle with the static background object.

5. The autonomous mobile vehicle control system as claimed in claim 1, wherein the processing module is configured to predict a future moving trajectory of the dynamic moving object in the field, and dynamically adjust the static safety trajectory according to the future moving trajectory and the movement of the autonomous mobile vehicle to obtain the dynamic safety trajectory for the future movement of the autonomous mobile vehicle.

6. The autonomous mobile vehicle control system as claimed in claim 5, wherein upon locating the dynamic moving object in the field, the processing module is configured to mark an identifier to the dynamic moving object and track the dynamic moving object according to the identifier.

7. The autonomous mobile vehicle control system as claimed in claim 1, wherein the processing module is configured to adjust a target position and a target speed of the autonomous mobile vehicle at each position parameter in real time according to at least one of a walking trajectory of the autonomous mobile vehicle, a required time to reach a road segment, and a penalty parameter for not reaching a target road segment so as to control the autonomous mobile vehicle to move smoothly in the field.

8. The autonomous mobile vehicle control system as claimed in claim 7, wherein the processing module is configured to dynamically control the autonomous mobile vehicle to move smoothly in the field and maintain the safety distance with the dynamic moving object by adjusting in real time at least one of a maximum longitudinal speed, a maximum longitudinal acceleration, a maximum lateral acceleration, and a front wheel steering angle limit.

9. The autonomous mobile vehicle control system as claimed in claim 1, further comprising an image sensor connected to the processing module, and the image sensor configured to generate an image data of the field, wherein the processing module is configured for:
detecting a first object in the field using the two-dimensional point cloud data and detecting a second object in the field using the image data,
identifying the first object in the field using a feature of the second object to obtain a tracking object in the field, and
locating the static background object and the dynamic moving object according to the tracking object.

10. The autonomous mobile vehicle control system as claimed in claim 1, wherein the processing module is configured to perform at least one of the following operations of:
adjusting a moving speed indicated by the dynamic safety trajectory when it is determined that a moving direction of the dynamic moving object is the same as or similar to a moving direction of the autonomous mobile vehicle so that a moving speed of the autonomous mobile vehicle is not higher than a moving speed of the dynamic moving object,
adjusting the dynamic safety trajectory to control a speed and a rotation radius of the autonomous mobile vehicle when there are still multiple dynamic moving objects around the autonomous mobile vehicle after the moving direction of the autonomous mobile vehicle changes so that the autonomous mobile vehicle maintains the safety distance with the multiple dynamic moving objects in multiple trajectory directions, and
adjusting the dynamic safety trajectory when it is determined that three are too many dynamic moving objects around the autonomous mobile vehicle and it is difficult for the autonomous mobile vehicle to maintain the safety distance with all the dynamic moving objects, or when the dynamic moving object has become an obstacle to move so that the autonomous mobile vehicle moves to a stop point and then stops moving, or moves to an alternative trajectory.

11. A safety trajectory control method for an autonomous mobile vehicle performed by an autonomous mobile vehicle control system, the autonomous mobile vehicle control system comprising a sensor module, a processing module connected to the sensor module, and an autonomous mobile vehicle, the safety trajectory control method comprising steps of:
sensing, by the sensor module, in a field to obtain a three-dimensional point cloud data,
projecting, by the processing module, the three-dimensional point cloud data to a horizontal plane to obtain a two-dimensional point cloud data,
analyzing, by the processing module, a projection distribution of the two-dimensional point cloud data on the horizontal plane to locate at least one static background object and at least one dynamic moving object in the field,
predicting, by the processing module, a static safety trajectory of the autonomous mobile vehicle for moving in the field and avoiding collision between the autonomous mobile vehicle and the static background object according to a position coordinate of the least one static background object, and
tracking, by the processing module, the movement of the dynamic moving object in the field in real time while the autonomous mobile vehicle moves in the field, and adjusting the static safety trajectory in real time with reference to the movement of the dynamic moving object to obtain a dynamic safety trajectory for controlling the movement of the autonomous mobile vehicle in the field so that the autonomous mobile vehicle and the dynamic moving object are maintained away from each other for at least a safety distance.

12. The safety trajectory control method as claimed in claim 11, wherein the field has a known specific range, and the autonomous mobile vehicle and the dynamic moving object share the same aisles and regions within the specific range; wherein in the step of sensing, by the sensor module, in a field to obtain a three-dimensional point cloud data, the sensor module senses surroundings of the autonomous mobile vehicle to obtain the three-dimensional point cloud data; wherein in the step of tracking, by the processing module, the movement of the dynamic moving object in the field in real time, the processing module tracks the movement of multiple dynamic moving objects around the autonomous mobile device, and generates the dynamic safety trajectory that allows the autonomous mobile vehicle to rotate or move up to 360 degrees on a horizontal plane defined by an x-axis and a y-axis so that the autonomous mobile vehicle in motion maintains the safety distance away from a plurality of dynamic moving objects in all directions.

13. The safety trajectory control method as claimed in claim 11, wherein before obtaining the static safety trajectory comprises a step of:
converting an original trajectory of the autonomous mobile vehicle moving in the field into a state-space equation comprising a position information, a speed, and an acceleration of the autonomous mobile vehicle; wherein the static safety trajectory and the dynamic safety trajectory are trajectories represented by the state-space equation; wherein the original trajectory comprises a coordinate parameter and a time parameter.

14. The safety trajectory control method as claimed in claim 13, wherein after converting the original trajectory into the state-space equation, an initial static trajectory is generated using the state-space equation, and a spatial geometric boundary coordinate of the static background object is used to adjust the initial static trajectory to generate the static safety trajectory that avoids the collision between the autonomous mobile vehicle and the static background object.

15. The safety trajectory control method as claimed in claim 11, wherein the step of obtaining the dynamic safety trajectory comprises a step of:
predicting a future movement trajectory of the dynamic moving object in the field and dynamically adjusting the static safety trajectory according to the future movement trajectory and the movement of the autonomous mobile vehicle to obtain the dynamic safety trajectory for the future movement of the autonomous mobile vehicle.

16. The safety trajectory control method as claimed in claim 15, wherein after locating the dynamic moving object in the field, an identifier is marked to the dynamic moving object and the dynamic moving object is tracked according to the identifier.

17. The safety trajectory control method as claimed in claim 11, further comprising a step of:
adjusting a target position and a target speed of the autonomous mobile vehicle at each position parameter in real time according to at least one of a walking trajectory of the autonomous mobile vehicle, a required time to reach a road segment, and a penalty parameter for not reaching a target road segment so as to control the autonomous mobile vehicle to move smoothly in the field.

18. The safety trajectory control method as claimed in claim 17, further comprising a step of:
dynamically controlling the autonomous mobile vehicle to move smoothly in the field and maintain the safety distance away from the dynamic moving object by adjusting in real time at least one of a maximum longitudinal speed, a maximum longitudinal acceleration, a maximum lateral acceleration, and a front wheel steering angle limit.

19. The safety trajectory control method as claimed in claim 11, wherein the autonomous mobile vehicle control system comprises an image sensor connected to the processing module, and the image sensor is configured to generate an image data of the field, wherein the safety trajectory control method comprises steps of:
detecting a first object in the field using the two-dimensional point cloud data and detecting a second object in the field using the image data,
identifying the first object in the field using a feature of the second object to obtain a tracking object in the field, and
locating the static background object and the dynamic moving object according to the tracking object.

20. The safety trajectory control method as claimed in claim 11, further comprising at least one of steps of:
adjusting a moving speed indicated by the dynamic safety trajectory when it is determined that a moving direction of the dynamic moving object is the same as or similar to a moving direction of the autonomous mobile vehicle so that a moving speed of the autonomous mobile vehicle is not higher than a moving speed of the dynamic moving object,
adjusting the dynamic safety trajectory to control a speed and a rotation radius of the autonomous mobile vehicle when there are still multiple dynamic moving objects around the autonomous mobile vehicle after the moving direction of the autonomous mobile vehicle changes so that the autonomous mobile vehicle maintains the safety distance away from the multiple dynamic moving objects in multiple trajectory directions, and
adjusting the dynamic safety trajectory when it is determined that three are too many dynamic moving objects around the autonomous mobile vehicle and it is difficult for the autonomous mobile vehicle to maintain the safety distance away from all the dynamic moving objects, or when the dynamic moving object has become an obstacle to move so that the autonomous mobile vehicle moves to a stop point and then stops moving, or moves to an alternative trajectory.
